(19) United States
(12) Patent Application Publication
(10) Pub. No.: US 2013/0293682 A1
(43) Pub. Date: Nov. 7, 2013

(54) IMAGE CAPTURE DEVICE, IMAGE CAPTURE METHOD, AND PROGRAM

(71) Applicant: Shumpei Zouda, Kanagawa (JP)

(72) Inventor: Shumpei Zouda, Kanagawa (JP)

(73) Assignee: PANASONIC CORPORATION, Osaka (JP)

(21) Appl. No.: 13/996,148

(22) PCT Filed: Mar. 5, 2012
(86) PCT No.: PCT/JP2012/001510

§ 371 Date: Jun. 20, 2013

(30) Foreign Application Priority Data
Mar. 14, 2011 (JP) 2011-055308

(51) Int. Cl. H04N 13/02

(52) U.S. Cl. CPC H04N 13/0246
USPC 348/46

(57) ABSTRACT

Disclosed is an image capture device in which, in an image capture possibility determination unit 19, when determining whether or not image capturing is possible on the basis of a motion vector of an input image, if an amount of movement after image capturing of a first image corresponds to a possible image capturing position of a second image capturing location where a predetermined parallax is obtained, and the motion vector of the input image is equal to or smaller than a threshold value T1 for detecting a stationary state of the image capture device, the stationary state of the image capture device is determined to determine whether or not image capturing of the second image is possible.

### TECHNICAL FIELD

The present invention relates to an image capture device, an image capture method, and a program capable of capturing a stereoscopic image (3D image).

### BACKGROUND ART

As a stereoscopic image capturing method for use in generating a 3D image, there are a method (compound-eye 3D image capturing) in which two left and right images are captured using a camera having two image capturing optical systems, and a method (single-eye 3D image capturing) in which two images having a parallax are continuously captured by a camera having a single image capturing optical system. In the case of single-eye 3D image capturing, after one of a left image and a right image is captured, the camera is moved by a predetermined amount in a horizontal direction, and the other image is captured. The predetermined amount corresponds to a parallax.

As the related art relating to single-eye 3D image capturing, an image capture device in which an image capturing operation is performed continuously while the user is moving (panning) the camera in the horizontal direction (panning), and two images optimum for a stereoscopic image are extracted from images captured at positions closest to a binocular parallax and respectively recorded as a left, image and a right image is disclosed (for example, see PTL 1).

### CITATION LIST

### Patent Literature

PTL 1: JP-A-2009-103980
PTL 2: Japanese Patent No. 3931393

### SUMMARY OF INVENTION

### Technical Problem

In the single-eye 3D image capturing, according to the related art, as disclosed in PTL 1, the 3D image is generated using the two images captured while the user is moving the image capture device in the horizontal direction. For this reason, the images become captured images during moving, and the 3D image may be blurred depending on the image capturing conditions, for example, image capturing at a dark place or image capturing of a close-range view.

A general image capture device is known in which, when panoramic image capturing is performed in a camera-integrated video recorder, a motion detection result of a captured image is accumulated, a stationary state is detected after the accumulation result exceeds a predetermined value, and image capturing is performed after the stationary state is detected for a predetermined time, thereby obtaining an image with little blurring (for example, see PTL 2).

However, even if the panoramic image capturing method is applied to the single-eye 3D image capturing, since the user should keep the image capture device stationary at an image capturing position where a target parallax by the user is obtained, there is a problem in that image capturing is not easily performed.

The invention has been accomplished in consideration of the above-described situation, and an object of the invention is to allow a 3D image with little blurring to be easily captured when performing stereoscopic image capturing.

### Solution to Problem

An image capture device which performs stereoscopic image capturing to capture two images having a predetermined parallax, the image capture device comprising:

a motion detection unit which detects a motion of the image capture device after image capturing of a first image in the stereoscopic image capturing;

an image capturing condition acquisition unit which acquires an image capturing condition of an input image during or after image capturing of the first image;

an image capture possibility determination unit which detects a stationary state of the image capture device at a position where the predetermined parallax is obtained in accordance with an amount of motion of the image capture device and the image capturing condition, and determines whether or not image capturing of a second image is possible in the stereoscopic image capturing; and

an image capturing control unit which controls image capturing of the first image and the second image.

### Advantageous Effects of Invention

According to the invention, it is possible to allow a 3D image with little blurring to be easily captured when performing stereoscopic image capturing.

### BRIEF DESCRIPTION OF DRAWINGS

FIG. 1 is a block diagram showing a main part configuration of an image capture device according to a first embodiment of the invention.

FIG. 2 is a flowchart showing a processing operation during stereoscopic image capturing in the image capture device of the first embodiment.

FIGS. 3A to 3C are diagrams showing operation description of the image capture device of the first embodiment and an example of screen display.

FIG. 4 is a block diagram showing a main part configuration of an image capture device according to a second embodiment of the invention.

FIG. 5 is a flowchart showing a processing operation during stereoscopic image capturing in the image capture device of the second embodiment.

FIG. 6 is a diagram showing a setting example of a threshold value T1 for stationary state detection.

FIG. 7 is a block diagram showing a main part configuration of an image capture device according to a third embodiment of the invention.

FIG. 8 is a flowchart showing a processing operation during stereoscopic image capturing in the image capture device of the third embodiment.

FIG. 9 is a diagram showing a setting example of a threshold value T2 for second image capturing location determination.

FIGS. 10A to 10C are diagrams showing operation description of the image capture device of the third embodiment and an example of screen display.

### DESCRIPTION OF EMBODIMENTS

In this embodiment, as an example of an image capture device, a configuration example in which the invention is applied to an electronic apparatus having a still image capturing function, such as a digital still camera, a camera function-equipped portable terminal, such as a mobile phone or a smart phone, or the like will be described.

### First Embodiment

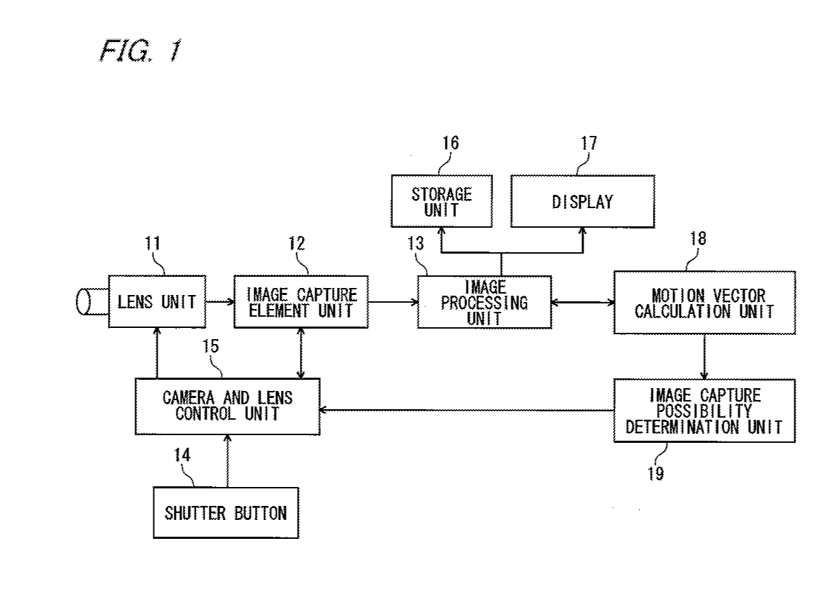

FIG. 1 is a block diagram showing a main part configuration of an image capture device according to a first embodiment of the invention.

An image capture device includes a lens unit 11 which forms an image of a subject, an image capture element unit 12 which captures the subject image formed by the lens unit 11, and an image processing unit 13 which performs image processing on the image captured by the image capture element unit 12. The image capture device also includes a shutter button 14 which inputs an image capturing instruction by a user operation, and a camera and lens control unit 15 which controls the lens unit 11 and the image capture element unit 12 to perform image capturing control in accordance with the image capturing instruction from the shutter button 14. The image capture device also includes a storage unit 16 which stores image data, and a display 17 which displays the image.

The lens unit 11 is an image capturing optical system having a single lens or a plurality of lenses, and includes a focus lens which focuses the subject image on the image capturing surface of the image capture element unit 12. The image capture element unit 12 has a CMOS image sensor, a CCD image sensor, or the like, and photoelectrically converts the subject image on the image capturing surface to output an image signal of the captured image.

The image processing unit 13 has a signal processor which performs signal processing of the image signal, and performs predetermined image processing, such as brightness adjustment, contrast adjustment, color correction, and edge enhancement, on the captured image. The camera and lens control unit 15 performs focusing control of the lens unit 11, shutter control of the image capture element unit 12, and the like as the image capturing control in accordance with the image capturing instruction from the shutter button 14, and executes still image capturing. The storage unit 16 has a volatile or nonvolatile memory, and stores a captured image of a captured still image. That is, the storage unit 16 corresponds to an internal memory which temporarily stores captured image data, an internal memory or a memory card which records image data after image capturing is completed, or the like. The camera and lens control unit 15 realizes the function of an image capturing control unit. The display 17 is constituted by a liquid crystal display or the like, and displays an input image (camera through image) of a motion image of the subject before an image capturing operation, an input image (captured image) of a still image after the image capturing operation, or the like.

The image capture device of this embodiment has a function of performing stereoscopic image capturing by single-eye 3D image capturing. When performing stereoscopic image capturing, after one of a left image and a right image is captured at an arbitrary position (first image capturing location), the user moves the image capture device by a predetermined amount in a horizontal direction, and the other image is captured at a position (second image capturing location) having a predetermined parallax.

The image capture device of this embodiment includes a motion vector calculation unit 18 which calculates a motion vector of the input image, and an image capture possibility determination unit 19 which determines the possibility of image capturing on the basis of the motion vector of the input image.

The motion vector calculation unit 18 calculates the motion vector of an input image (camera through image) of a motion image focused on the subject before an image capturing operation of a motion image, and detects a motion of an image. In this embodiment, the motion vector calculation unit 18 detects the amount of movement of the image capture device after the first image of the left image or the right image is captured. The motion vector calculation unit 18 realizes the function of a motion detection unit. The motion detection unit is not limited to a motion detection unit which detects a motion of an image, such as the motion vector of the input image, a motion detection unit, such as an acceleration sensor, which detects a motion of the image capture device itself may be used.

On the basis of the calculated motion vector of the input image, when the amount of movement after the first image is captured corresponds to the position (possible image capturing position) of the second image capturing location where a predetermined parallax is obtained, and the motion vector is equal to or smaller than a predetermined value, the image capture possibility determination unit 19 determines that image capturing of the second image is possible. The camera and lens control unit 15 performs the image capturing control to execute image capturing of the first image, and then, when the image capture possibility determination unit 19 determines that image capturing is possible, performs the image capturing control again to execute image capturing of the second image.

In regard to the camera and lens control unit 15, the motion vector calculation unit 18, and the image capture possibility determination unit 19, a processing unit which is constituted by a computer or the like having a processor performing various kinds of information processing, a memory, and the like executes a predetermined program, whereby the functions of the respective units are realized.

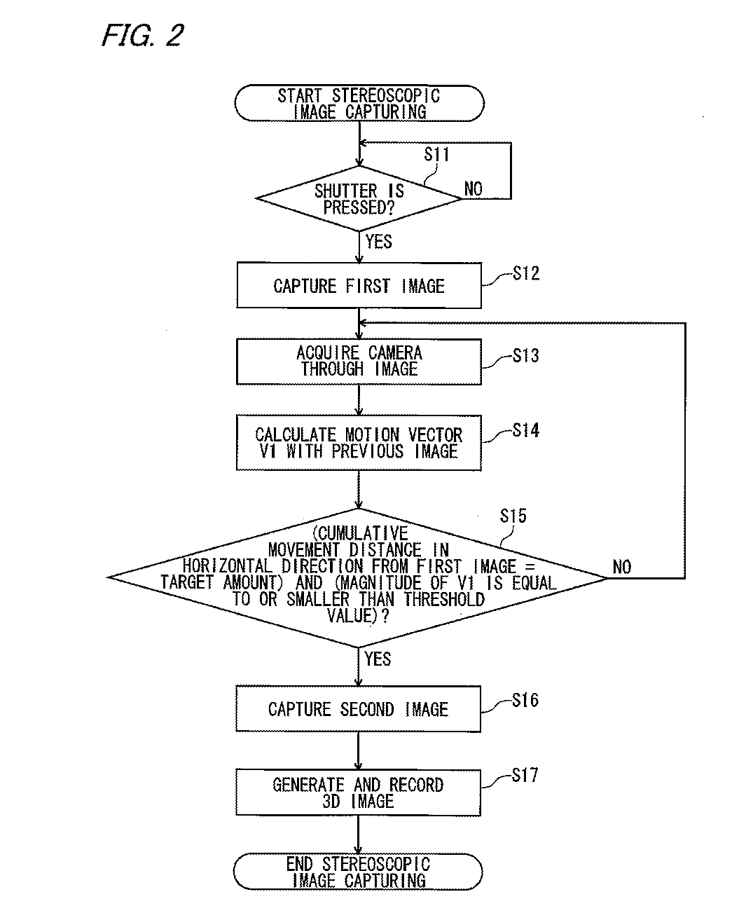

Next, the operation of the image capture device of the first embodiment will be described. FIG. 2 is a flowchart showing a processing operation during stereoscopic image capturing in the image capture device of the first embodiment.

If the image capture device starts the operation of stereoscopic image capturing, first, the camera and lens control unit 15 determines whether or not the shutter button 14 is pressed and determines the possibility of image capturing of the first image (Step S11). When the shutter button 14 is pressed, the camera and lens control unit 15 performs the image capturing control of the lens unit 11 and the image capture element unit 12 to capture the first image (Step S12).

Next, the motion vector calculation unit 18 acquires a camera through image from the image processing unit 13 (Step S13). The motion vector calculation unit 18 calculates a motion vector V1 between frames of an input image of two frames and a previous image (Step S14). The image capture possibility determination unit 19 determines the possibility of image capturing of the second image on the basis of the calculated motion vector V1 (Step S15). At this time, the image capture possibility determination unit 19 determines whether or not a cumulative movement distance in the horizontal direction from the image capturing of the first image is a target amount and the magnitude of the current motion vector V1 is equal to or smaller than a predetermined threshold value. The target amount of the cumulative movement distance corresponds to the distance from the first image capturing location to the second image capturing location (possible image capturing position) where an optimum stereoscopic view is possible and a predetermined parallax is obtained.

In Step S15, when the image capture possibility determination unit 19 determines that image capturing of the second image is possible, the camera and lens control unit 15 performs image capturing control of the lens unit 11 and the image capture element unit 12 to capture the second image (Step S16). The captured first and second images are stored in the storage unit 16. The image processing unit 13 generates a 3D image by the first image and the second image, and records the 3D image in the storage unit 16 (Step S17).

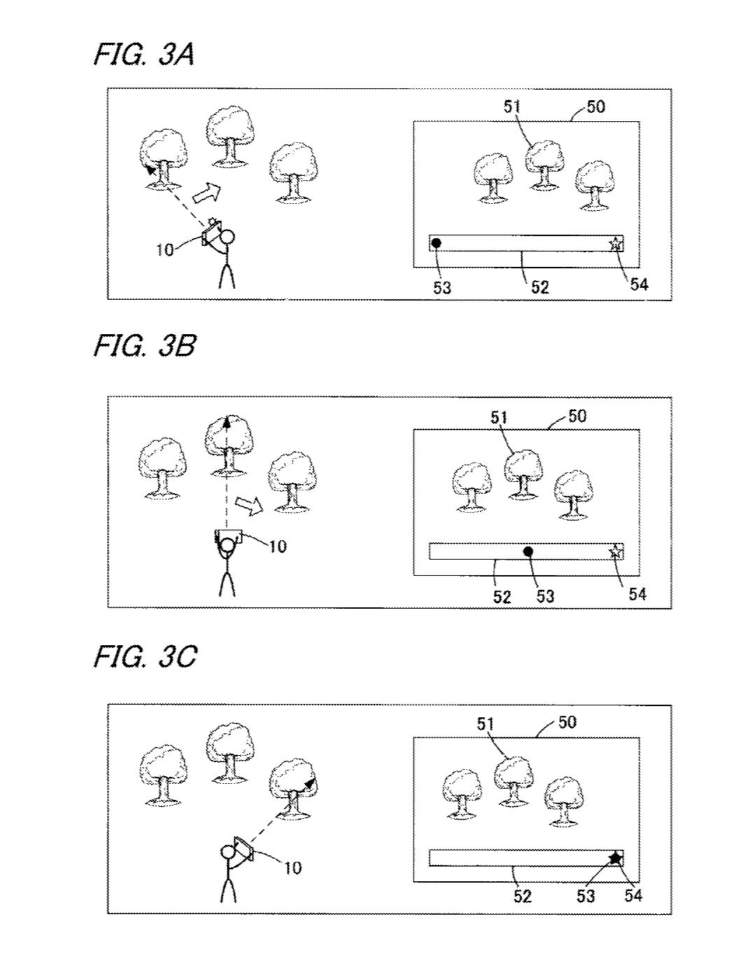

Next, in the first embodiment, an operation on the image capture device and screen display of the display 17 during stereoscopic image capturing will be described. FIGS. 3A to 3C are diagrams showing operation description of the image capture device of the first embodiment and an example of screen display. In this embodiment, it is assumed that a left image is captured as the first image, and then a right image is captured as the second image.

As shown in FIG. 3A, the user places the image capture device 10 toward the subject and presses the shutter button 14 at the first image capturing location to capture the first image. If the shutter button 14 is depressed during image capturing of the first image, a guidance image 52 representing the second image capturing location is displayed on a display screen 50 of the display 17 along with a preview image 51 of the subject by the camera through image. The guidance image 52 is the index of bar display extended in the horizontal direction, and a current position mark 53 representing the position of the current image capturing location and an image capturing position mark 54 representing the position of the second image capturing location are shown. The guidance image 52 has the length of the bar which changes in accordance with the distance to the second image capturing location where a predetermined parallax is obtained. The user moves (pans) the image capture device 10 in the right horizontal direction so as to capture the second image.

As shown in FIG. 3B, the current position mark 53 in the bar display of the guidance image 52 displayed on the display screen 50 moves in accordance with the movement circumstance of the image capture device 10 in the horizontal direction. The user further moves (pans) the image capture device 10 in the right horizontal direction until the image capture device 10 turns toward the position of the second image capturing location.

As shown in FIG. 3C, the user moves the image capture device 10 to the position of the second image capturing location in the right horizontal direction using the guidance image 52 as a guide such that the current position mark 53 overlaps the image capturing position mark 54, and keeps the image capture device 10 stationary. The image capture device 10 determines that the image capture device 10 moves to the second image capturing location by the cumulative movement distance in the horizontal direction from the image capturing of the first image on the basis of the motion vector V1 of the input image, and also determines that the image capture device 10 is substantially kept stationary when the magnitude of the motion vector V1 is equal to or smaller than a predetermined threshold value. When the above two conditions are satisfied, the image capture device 10 determines that the image capture device 10 is kept stationary at the second image capturing location, and performs the image capturing control to automatically capture the second image. Instead of the single motion vector V1, when all motion vectors in a plurality of continuous frames on the time axis are equal to or smaller than the threshold value, it may be determined that the image capture device 10 is kept stationary.

Instead of the camera and lens control unit 15 automatically capturing the second image, the user may press the shutter button at the second image capturing location to manually capture the second image.

An image capturing location presentation unit for allowing the user to recognize the second image capturing location is not limited to the display of the guidance image described above. For example, as the display on the display screen, in addition to the guidance image, display, such as characters of “please move right”, “please stop”, or the like, or a symbol, may be used.

The image capturing location presentation unit may give notification by sound or voice. For example, the use of guide voice of “please move right”, “please stop”, or the like, or the use of beep sound is considered. When beep sound is used, intermittent beep sound may be used during horizontal movement, and continuous beep sound may be used if the second image capturing location is reached, or low beep sound is used during horizontal movement, and high beep sound may be used if the second image capturing location is reached.

The image capturing location presentation unit may give notification by vibration of a vibrator or the like. When a vibrator is used, the vibrator is vibrating during horizontal movement, and vibration stops if the second image capturing location is reached. The image capturing location presentation unit may give notification by light of a lamp or the like. When light is used, the lamp may blink during horizontal movement, and the lamp may be continuously turned on if the second image capturing location is reached. A lamp having a meaning “please move right” and a lamp having a meaning “please stop” may be provided depending on the position of the lamp, or the like.

In this way, according to this embodiment, image capturing of the second image can be performed in a state were the image capture device is kept stationary, there is little possibility that a captured image is blurred, and a stable 3D image is obtained. When the motion vector is equal to or smaller than the predetermined value, keeping stationary is detected, whereby the image capture device is easily kept in the stationary state to capture the second image. Therefore, it is possible to easily capture a 3D image with little blurring.

### Second Embodiment

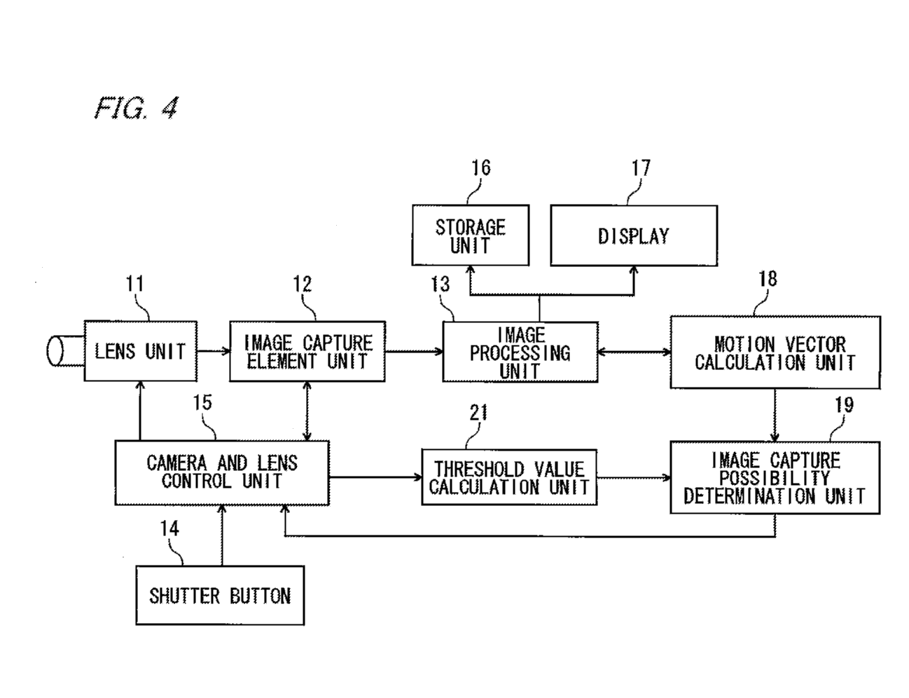

FIG. 4 is a block diagram showing a main part configuration of an image capture device according to a second embodiment of the invention.

An image capture device of a second embodiment includes a threshold value calculation unit 21 which calculates a threshold value of a motion vector for determining the stationary state, and is an example where the threshold value for stationary state detection can be changed. Other configurations are the same as those in the first embodiment, the same constituent element are represented by the same reference signs, and the description thereof will not be repeated. Description will be provided focusing on a difference from the first embodiment.

The threshold value calculation unit 21 acquires the image capturing condition (first image information) during image capturing of the first image from the camera and lens control unit 15, and calculates and determines a threshold value T1 for detecting the stationary state of the image capture device on the basis of the first image information. As the first image information, for example, brightness information by the result of photometry during image capturing of the first image, the shutter speed, the aperture value, or the like is used. The distance from the subject measured by autofocus (not shown) during image capturing of the first image may be used. That is, the threshold value calculation unit 21 realizes the function of an image capturing condition acquisition unit which acquires an image capturing condition of an input image. As the first image information, information regarding a preview image after first image capturing (before second image capturing) may be used.

Using the motion vector V1 of the input image calculated by the motion vector calculation unit 18 and the threshold value T1 calculated by the threshold value calculation unit 21, when the motion vector V1 is equal to or smaller than the predetermined threshold value T1, the image capture possibility determination unit 19 detects the stationary state and determines that image capturing of the second image is possible. When the brightness information of the first image is used as the first image information, the threshold value calculation unit 21 sets the threshold value T1 in accordance with brightness of the image to be greater when the brightness information is brighter than a predetermined value compared to when the brightness information is darker than the predetermined value. When the first image is bright, even if there is a little motion, the image capture possibility determination unit 19 determines that the image capture device is kept stationary and performs image capturing of the second image.

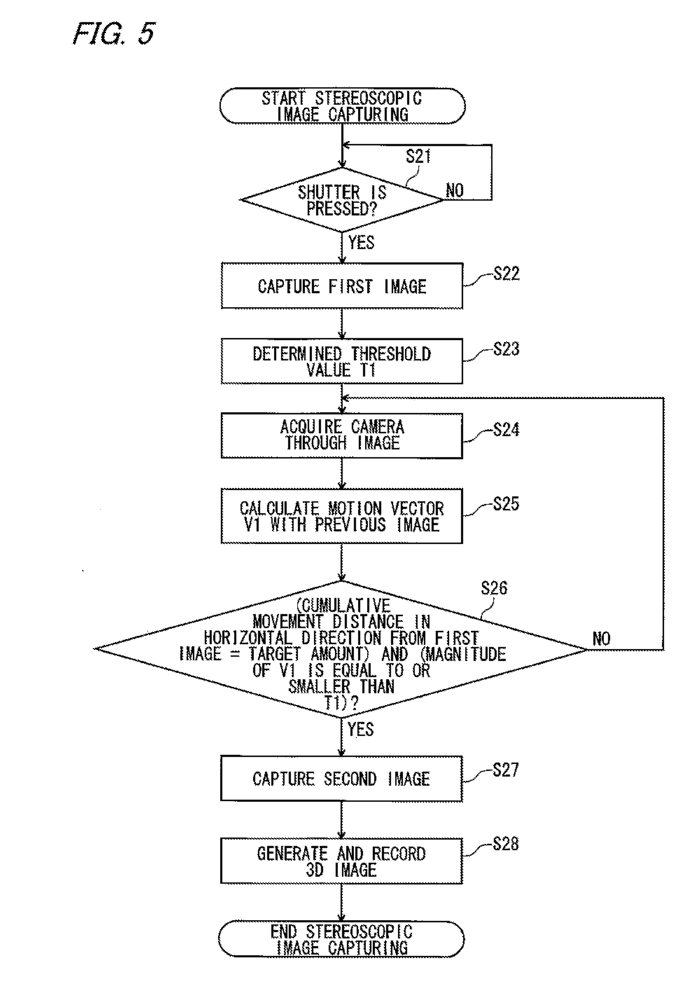

Next, the operation of the image capture device of the second embodiment will be described. FIG. 5 is a flowchart showing a processing operation during stereoscopic image capturing in the image capture device of the second embodiment.

If the image capture device starts the operation of stereoscopic image capturing, first, the camera and lens control unit 15 determines whether or not the shutter button 14 is pressed and determines the possibility of image capturing of the first image (Step S21). When the shutter button 14 is pressed, the camera and lens control unit 15 performs the image capturing control of the lens unit 11 and the image capture element unit 12 to capture the first image (Step S22).

Next, the threshold value calculation unit 21 acquires the first image information from the camera and lens control unit 15, and determines the threshold value T1 for detecting the stationary state of the image capture device in accordance with the first image information (Step S23). For example, on the basis of the brightness information of the first image, when the brightness information is brighter than a predetermined value and the shutter speed can be set to be short, the threshold value T1 is set to be greater than when the brightness information is darker than the predetermined value.

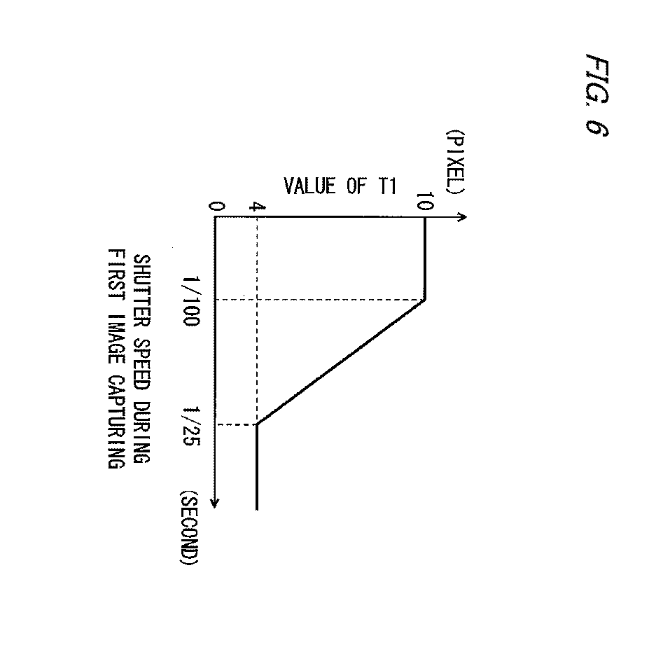

FIG. 6 is a diagram showing a setting example of a threshold value T1 for stationary state detection. In the example of the drawing, as the brightness information of the first image, the shutter speed during image capturing of the first image is used. When the shutter speed is equal to or smaller than 1/100 seconds and the image is bright, the threshold value T1 is set to 10 pixels. When the shutter speed is 1/100 seconds to 1/25 seconds, the threshold value T1 gradually decreases from 10 pixels to 4 pixels in proportion to the length of the shutter speed. When the shutter speed is equal to or greater than 1/25 seconds and the image is dark, the threshold value T1 is set to 4 pixels.

Subsequently, the motion vector calculation unit 18 acquires a camera through image from the image processing unit 13 (Step S24). The motion vector calculation unit 18 calculates a motion vector V1 between frames of an input image of two frames and a previous image (Step S25). The image capture possibility determination unit 19 determines the possibility of image capturing of the second image on the basis of the calculated motion vector V1 and the threshold value T1 (Step S26). At this time, the image capture possibility determination unit 19 determines whether or not the cumulative movement distance in the horizontal direction from the image capturing of the first image is a target amount and the magnitude of the current motion vector V1 is equal to or smaller than the predetermined threshold value T1.

In Step S26, when the image capture possibility determination unit 19 determines that image capturing of the second image is possible, the camera and lens control unit 15 performs image capturing control of the lens unit 11 and the image capture element unit 12 to capture the second image (Step S27). The captured first and second images are stored in the storage unit 16. The image processing unit 13 generates a 3D image by the first image and the second image, and records the 3D image in the storage unit 16 (Step S28).

Although the above description has been provided on the basis of the brightness information, the threshold value calculation unit 21 may change the setting of the threshold value T1 in accordance with the distance to the subject measured by autofocus in addition to the brightness information. For example, when the distance is greater than a predetermined value, the threshold value T1 is set to be greater compared to when the distance is smaller than the predetermined value. When the first image is a distant view, even if there is a little motion, the image capture possibility determination unit 19 determines that the image capture device is kept stationary and performs image capturing of the second image.

In this way, in this embodiment, the threshold value for determining the stationary state of the image capture device is changed by the image capturing condition, that is, the information regarding the first image or the preview image after image capturing of the first image. Accordingly, it is not necessary to keep the image capture device completely stationary so as to capture the second image depending on the image capturing condition, making it easy to capture a 3D image. For example, when a captured image is bright and the shutter speed may be set to be short, or when a distant view is captured, even if the image capture device slightly moves, the second image can be captured, thereby easily capturing a 3D image with little blurring.

### Third Embodiment

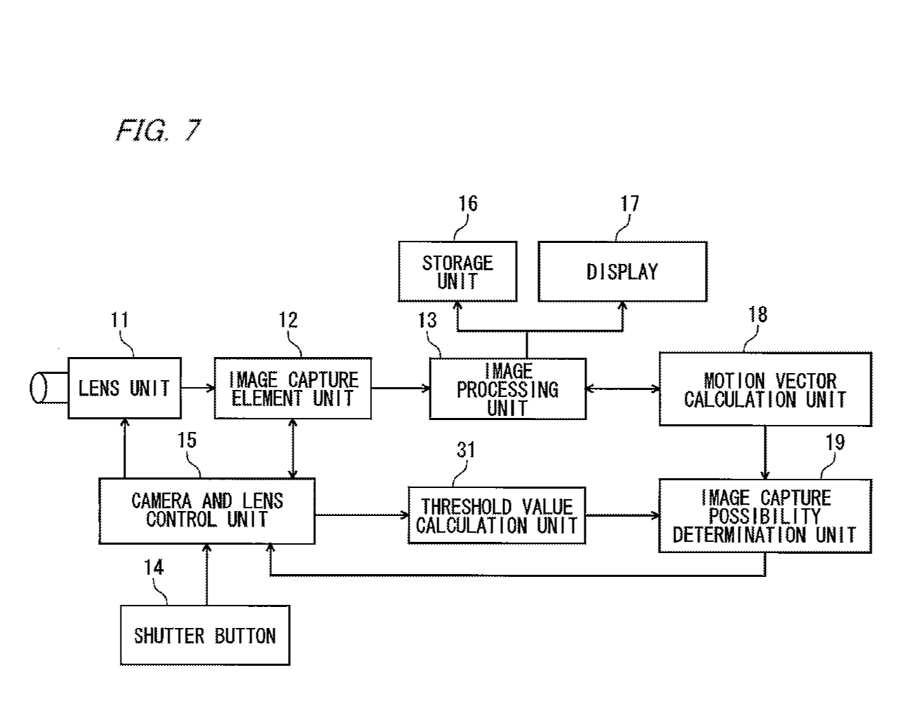

FIG. 7 is a block diagram showing a main part configuration of an image capture device according to a third embodiment of the invention.

An image capture device of a third embodiment is an example where the function of a threshold value calculation unit 31 is changed, a threshold value T2 for second image capturing location determination is set along with the threshold value T1 for stationary state detection, and the threshold values T1 and T2 can be changed. Other configurations are the same as those in the first and second embodiments, the same constituent elements are represented by the same reference signs, and the description thereof will not be repeated. Description will be provided focusing on a difference from the first and second embodiments.

The threshold value calculation unit 31 acquires information (first image information) during image capturing of the first image from the camera and lens control unit 15, and calculates and determines the threshold value T1 for detecting the stationary state of the image capture device and the threshold value T2 for second image capturing location determination on the basis of the first image information. In regard to the threshold value T1, as the first image information, for example, brightness information by the result of photometry during image capturing of the first image, the shutter speed, or the like may be used. In regard to the threshold value T2, for example, target parallax information for allowing an appropriate stereoscopic view, or the like is used in accordance with the image capturing circumstance of the first image. The distance to the subject measured by autofocus may be used.

A parallax between two images of a 3D image is changed depending on the circumstance of the subject or the like and set, whereby an appropriate stereoscopic view is possible regardless of the subject. For example, when the distance to the subject is small, the parallax decreases, and when the distance is great, the parallax increases, whereby a natural stereoscopic effect is obtained. The threshold value T2 is used to determine the allowable range of the possible image capturing position of the second image according to the amount of target parallax.

The image capture possibility determination unit 19 determines the possibility of image capturing of the second image using the motion vector V1 of the input image calculated by the motion vector calculation unit 18 and the threshold values T1 and T2 calculated by the threshold value calculation unit 31. At this time, the image capture possibility determination unit 19 determines that image capturing of the second image is possible when the amount of movement after image capturing of the first image is within a range (possible image capturing position) having the width of the threshold value T2 with respect to the position of the second image capturing location where a predetermined parallax is obtained, and when the motion vector V1 is equal to or smaller than the predetermined threshold value T1 it is determined that image capturing of the second image is possible. That is, the image capture possibility determination unit 19 detects the stationary state within the allowable range of the second image capturing location, and determines that image capturing of the second image is possible.

When the brightness information of the first image is used as the first image information for calculating the threshold value T1, as in the second embodiment, the threshold value calculation unit 31 sets the threshold value T1 in accordance with brightness of the image to be greater when the brightness information is brighter than a predetermined value compared to when the brightness information is darker than the predetermined value. When the first image is bright, even if there is a little motion, the image capture possibility determination unit 19 determines that the image capture device is kept stationary and performs image capturing of the second image.

When target parallax information is used as the first image information for calculating the threshold value T2, the threshold value calculation unit 31 sets the threshold value T2 in accordance with the target parallax to be smaller when the parallax is smaller than a predetermined value and to be greater when the parallax is greater than the predetermined value. The image capture possibility determination unit 19 determines the range of the distance with the width changed depending on the magnitude of the target parallax as the second image capturing location.

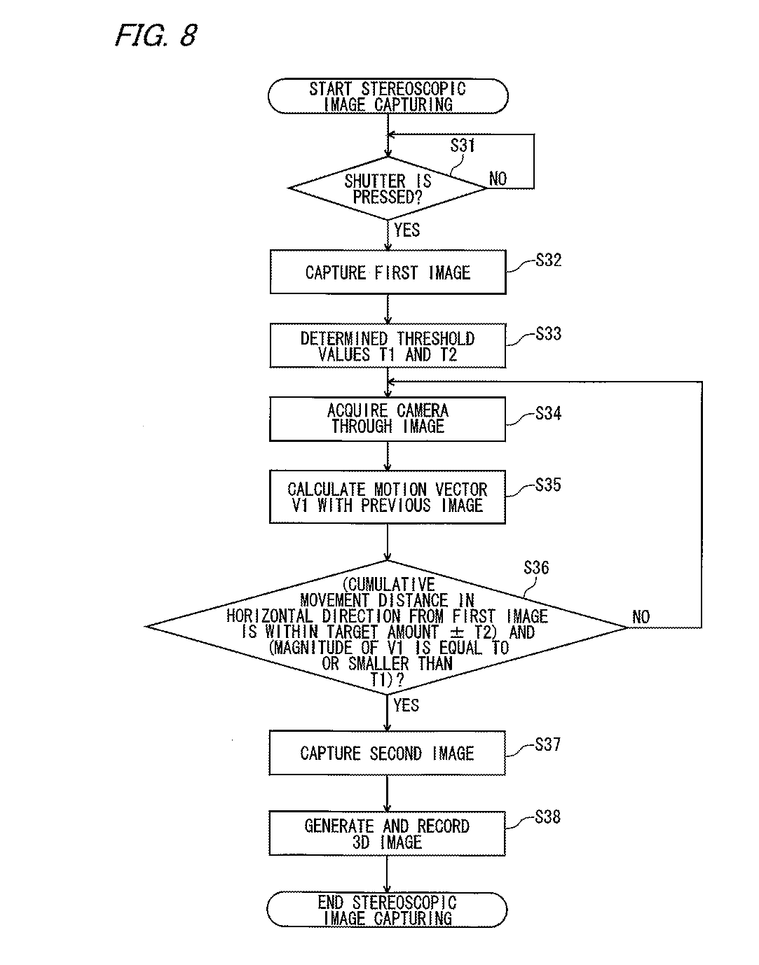

Next, the operation of the image capture device of the third embodiment will be described. FIG. 8 is a flowchart showing a processing operation during stereoscopic image capturing in the image capture device of the third embodiment.

If the image capture device starts the operation of stereoscopic image capturing, first, the camera and lens control unit 15 determines whether or not the shutter button 14 is pressed and determines the possibility of image capturing of the first image (Step S31). When the shutter button 14 is pressed, the camera and lens control unit 15 performs the image capturing control of the lens unit 11 and the image capture element unit 12 to capture the first image (Step S32).

Next, the threshold value calculation unit 31 acquires the first image information from the camera and lens control unit 15, and determines the threshold value T1 for detecting the stationary state of the image capture device and the threshold value T2 for second image capturing location determination in accordance with the first image information (Step S33). As in the second embodiment, the threshold value T1 is set as in the example shown in FIG. 6. The threshold value T2 is set in accordance with the image capturing circumstance of the first image to be smaller when the target parallax is small and to be greater when the parallax is great. In this case, in regard to the image capturing position of the second image, when the target parallax is great, a comparatively wide range is permitted, and when the parallax is small, only a narrow range is permitted, making it possible to perform appropriate position control of the second image capturing position according to the amount of optimum parallax.

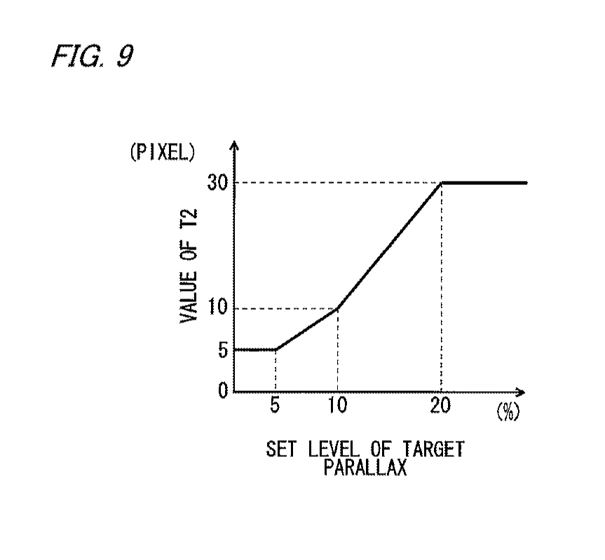

FIG. 9 is a diagram showing a setting example of a threshold value T2 for second image capturing location determination. In the example of the drawing, as the image capturing circumstance information of the first image, the set level of the target parallax of the second image with respect to the first image is used. The set level of the parallax represents the ratio of the amount of deviation of the first image and the second image with respect to the horizontal width of the image in terms of %. When the set level of the target parallax is equal to or smaller than 5%, the threshold value T2 is set to 5 pixels. When the set level of the target parallax is 5% to 10%, the threshold value T2 gradually increases from 5 pixels to 10 pixels in proportion to the set level of the parallax. When the set level of the target parallax is 10% to 20%, the threshold value T2 gradually increases from 10 pixels to 30 pixels in proportion to the set level of the parallax. When the set level of the target parallax is equal to or greater than 20%, the threshold value T2 is set to 30 pixels.

Subsequently, the motion vector calculation unit 18 acquires a camera through image from the image processing unit 13 (Step S34). The motion vector calculation unit 18 calculates a motion vector V1 between frames of an input image of two frames and a previous image (Step S35). The image capture possibility determination unit 19 determines the possibility of image capturing of the second image on the basis of the calculated motion vector V1 and the threshold values T1 and T2 (Step S36). At this time, the image capture possibility determination unit 19 determines whether or not the cumulative movement distance in the horizontal direction from the image capturing of the first image is within a range of a target amount±T2 and the magnitude of the current motion vector V1 is equal to or smaller than the predetermined threshold value T1.

In Step S36, when the image capture possibility determination unit 19 determines that image capturing of the second image is possible, the camera and lens control unit 15 performs image capturing control of the lens unit 11 and the image capture element unit 12 to capture the second image (Step S37). The captured first and second images are stored in the storage unit 16. The image processing unit 13 generates a 3D image by the first image and the second image, and records the 3D image in the storage unit 16 (Step S38).

Although a case where the threshold value T2 is changed in accordance with the amount of optimum parallax has been described, the threshold value calculation unit 31 may change the setting of the threshold value T2 in accordance with the distance to the subject measured using an autofocus lens. For example, when the distance to the subject is small, the threshold value T2 is set to be smaller, and when the distance is great, the threshold value T2 is set to be greater. In this case, in regard to the image capturing position of the second image, when the target distance is long, a comparatively wide range is permitted, and when the distance is short, only a narrow range is permitted, making it possible to perform appropriate position control of the second image capturing position according to the distance to the subject.

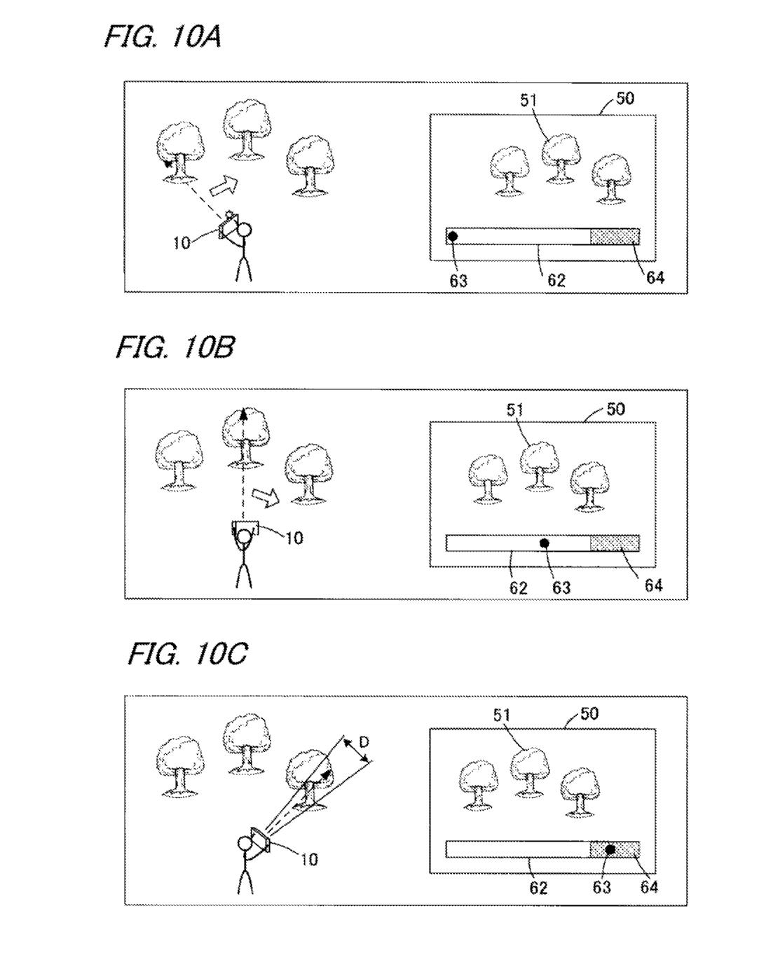

Next, an operation on the image capture device and screen display of the display 17 during stereoscopic image capturing in the third embodiment will be described. FIGS. 10A to 10C are diagrams showing operation description of the image capture device of the first embodiment and an example of screen display. In this embodiment, it is assumed that a left image is captured as the first image, and then a right image is captured as the second image.

As shown in FIG. 10A, the user places the image capture device 10 toward the subject and presses the shutter button 14 at the first image capturing location to capture the first image. If the shutter button 14 is pressed during image capturing of the first image, a guidance image 62 representing the second image capturing location is displayed on the display screen 50 of the display 17 along with the preview image 51 of the subject by the camera through image. The guidance image 62 is the index of bar display extended in the horizontal direction, and a current position mark 63 representing the position of the current image capturing location and an image capturing position zone display 64 representing the range of a position to be permitted as the second image capturing location are shown. The guidance image 62 has the length of the bar which changes in accordance with the distance to the allowable range of the second image capturing location where a predetermined parallax is obtained. The user moves (pans) the image capture device 10 in the right horizontal direction so as to capture the second image.

As shown in FIG. 10B, the current position mark 63 in the bar display of the guidance image 62 displayed on the display screen 50 moves in accordance with the movement circumstance of the image capture device 10 in the horizontal direction. The user further moves (pans) the image capture device 10 in the right horizontal direction until the image capture device 10 turns toward the position of the second image capturing location.

As shown in FIG. 10C, the user moves the image capture device 10 in the right horizontal direction to an allowable range D of the second image capturing location using the guidance image 62 as a guide such that the current position mark 63 enters image capturing position zone display 64, and keeps the image capture device 10 stationary. The image capture device 10 determines that the image capture device 10 moves to the allowable range of the second image capturing location by the cumulative movement distance in the horizontal direction from the image capturing of the first image on the basis of the motion vector V1 of the input image, and also determines that the image capture device 10 is substantially kept stationary when the magnitude of the motion vector V1 is equal to or smaller than a predetermined threshold value. When the above two conditions are satisfied, the image capture device 10 determines that the image capture device 10 is kept stationary within the range of the second image capturing location, and performs the image capturing control to automatically capture the second image.

In this way, according to this embodiment, the allowable range of the second image capturing location is set, and a given margin is provided before and after the image capturing position of the second image where the optimum parallax is obtained, whereby image capturing is possible even if the position where the user should keep the image capture device stationary is slightly deviated. For this reason, it is possible to easily capture a 3D image having a predetermined parallax with little blurring. Since the allowable range of the second image capturing location is changed depending on the image capturing circumstance, it is possible to take a wide allowable range of the image capturing position of the second image, at which the image capture device should be kept stationary, under any image capturing condition, making it easy to capture a 3D image. For example, during image capturing of a subject in a short distance, the parallax decreases to narrow the allowable range, and during image capturing of a subject in a long distance, the parallax increases to widen the allowable range. Therefore, in an image capturing condition which is less sensitive the parallax, it is possible to increase the margin of the second image capturing location, making it easy to capture a 3D image.

Various forms of the embodiment according to the invention include the following forms.

An image capture device which performs stereoscopic image capturing to capture two images having a predetermined parallax, the image capture device including a motion detection unit which detects a motion of the image capture device after image capturing of a first image in the stereoscopic image capturing, an image capturing condition acquisition unit which acquires an image capturing condition of an input image during or after image capturing of the first image, an image capture possibility determination unit which detects a stationary state of the image capture device at a position where the predetermined parallax is obtained in accordance with an amount of motion of the image capture device and the image capturing condition, and determines whether or not image capturing of a second image is possible in the stereoscopic image capturing, and an image capturing control unit which controls image capturing of the first image and the second image.

With the above configuration, the stationary state of the image capture device at the second image capturing location where the predetermined parallax is obtained is detected in accordance with the amount of motion of the image capture device and the image capturing condition. Accordingly, for example, when brightness information is used as the image capturing condition, if the input image is bright and the amount of motion is equal to or smaller than a predetermined amount, it is possible to determine that the image capture device is in the stationary state, making it possible to easily capture the second image in the stationary state. For this reason, it becomes possible to easily capture a 3D image with little blurring when performing stereoscopic image capturing.

The above-described image capture device, in which, when the amount of motion of the image capture device is equal to or smaller than a threshold value for stationary state detection set in accordance with the image capturing condition, the image capture possibility determination unit determines that the image capture device is in the stationary state.

With the above configuration, it is possible to determine the stationary state of the image capture device using the threshold value for stationary state detection set in accordance with the image capturing condition, making it possible to easily capture the second image in the stationary state.

The image capture device, in which the image capturing condition is brightness information of the input image.

With the above configuration, for example, if the input image is bright and the amount of motion is equal to or smaller than a predetermined amount, it is possible to determine that the image capture device is in the stationary state in accordance with the amount of motion of the image capture device and the brightness information of the input image, making it possible to easily capture the second image in the stationary state.

The image capture device further including a threshold value calculation unit which calculates the threshold value for stationary state detection in accordance with the brightness information, in which, when the brightness information is brighter than a predetermined value, the threshold value calculation unit increases the threshold value for stationary state detection compared to when the brightness information is darker than the predetermined value.

With the above configuration, when the input image is brighter than the predetermined value, the threshold value for stationary state detection increases. Accordingly, when an image is bright, even if there is a little motion, it is possible to determine that the image capture device is in the stationary state, making it possible to easily capture the second image.

The image capture device, in which the image capturing condition is a distance from a subject during image capturing.

With the above configuration, in accordance with the amount of motion of the image capture device and the distance from the subject, for example, when the distance from the subject is larger and the amount of motion is equal to or smaller than a predetermined amount, it is possible to determine that the image capture device is in the stationary state, making it possible to easily capture the second image in the stationary state.

The image capture device further including a threshold value calculation unit which calculates the threshold value for stationary state detection in accordance with the distance from the subject, in which, when the distance is greater than a predetermined value, the threshold value calculation unit increases the threshold value for stationary state detection compared to when the distance is smaller than the predetermined value.

With the above configuration, when the distance from the subject is greater than the predetermined value, the threshold value for stationary state detection increases. Accordingly, in the case of image capturing of a close-range view, even if there is a little motion, it is possible to determine that the image picture device is in the stationary state, making it possible to easily capture the second image.

The above-described image capture device, in which, when an amount of movement from an image capturing position of the first image becomes a predetermined amount, on the basis of the amount of motion of the image capture device, the image capture possibility determination unit determines that the image capture device is at the possible image capturing position of the second image where the predetermined parallax is obtained.

With the above configuration, it becomes possible to determine the position of the second image capturing location where a predetermined parallax is obtained on the basis of the amount of motion of the image capture device.

The image capture device, in which, when the amount of movement from the image capturing position of the first image falls within a predetermined allowable range, the image capture possibility determination unit determines that the image capture device is at the possible image capturing position of the second image where the predetermined parallax is obtained.

With the above configuration, when the amount of movement from the image capturing position of the first image falls within the allowable range, it is possible to determine that the image capture device is at the possible image capturing position of the second image, making it possible to easily perform image capturing of the second image in which a predetermined parallax is obtained.

The image capture device further including a threshold value calculation unit which calculates a threshold value for second image capturing location determination to determine the allowable range of the amount of movement, in which the threshold value calculation unit changes the threshold value for second image capturing location determination in accordance with the amount of optimum parallax appropriate for stereoscopic view set as the predetermined parallax.

With the above configuration, it is possible to determine the position of the second image capturing location using the threshold value for second image capturing location determination set so as to be changed in accordance with the amount of optimum parallax, making it possible to easily perform image capturing of the second image in which a predetermined parallax is obtained.

The image capture device, in which, when the optimum parallax is greater than a predetermined amount, the threshold value calculation unit increases the threshold value for second image capturing location determination compared to when the optimum parallax is smaller than the predetermined amount.

With the above configuration, when the optimum parallax is greater than the predetermined amount, the threshold value for second image capturing location determination increases. Accordingly, for example, when the optimum parallax according to the distance to the subject or the like increases, it is possible to capture the second image within a range of parallax having a certain width, making it possible to easily capture the second image.

The image capture device further including a threshold value calculation unit which calculates a threshold value for second image capturing location determination to determine the allowable range of the amount of movement, in which the threshold value calculation unit changes the threshold value for second image capturing location determination in accordance with a distance to the subject during image capturing as the image capturing condition.

With the above configuration, it is possible to determine the position of the second image capturing location using the threshold value for second image capturing location determination set so as to be changed in accordance with the distance to the subject, making it possible to easily perform image capturing of the second image in which a predetermined parallax is obtained.

The above-described image capture device, in which, when the distance to the subject is greater than a predetermined amount, the threshold value calculation unit increases the threshold value for second image capturing location determination compared to when the distance to the subject is smaller than the predetermined amount.

With the above configuration, when the distance to the subject is greater than the predetermined amount, the threshold value for second image capturing location determination increases. Accordingly, when the optimum parallax increases during image capturing of a distant view, it is possible to capture the second image within a range of parallax having a certain width, making it possible to easily perform the second image.

The above-described image capture device further including an image capturing location presentation unit which presents an image capturing location where image capturing of the second image is possible.

With the above configuration, the image capturing location of the second image is presented, whereby the user can recognize the image capturing location where image capturing of the second image is possible, can move the image capture device in conformity with this location, and can perform image capturing of the second image.

The image capture device, in which the image capturing location presentation unit gives notification of the image capturing location of the second image by at least one of an image, sound, voice, vibration, and light.

With the above configuration, the image capturing location of the second image is presented using an image, sound, voice, vibration, light, or the like, whereby the user can easily recognize the image capturing location where image capturing of the second image is possible.

An image capture method in an image capture device which performs stereoscopic image capturing to capture two images having a predetermined parallax, the image capture method including a step of detecting a motion of the image capture device after image capturing of a first image in the stereoscopic image capturing, a step of acquiring an image capturing condition of an input image during or after image capturing of the first image, a step of detecting a stationary state of the image capture device at a position where the predetermined parallax is obtained in accordance with an amount of motion of the image capture device and the image capturing condition, and determining whether or not image capturing of a second image is possible in the stereoscopic image capturing, and a step of controlling image capturing of the first image and the second image.

A program which, in an image capture device performing stereoscopic image capturing to capture two images having a predetermined parallax, causes a computer to execute a step of detecting a motion of the image capture device after image capturing of a first image in the stereoscopic image capturing, a step of acquiring an image capturing condition of an input image during or after image capturing of the first image, a step of detecting a stationary state of the image capture device at a position where the predetermined parallax is obtained in accordance with an amount of motion of the image capture device and the image capturing condition, and determining whether or not image capturing of a second image is possible in the stereoscopic image capturing, and a step of controlling image capturing of the first image and the second image.

Various changes and applications of the present invention may be made by those skilled in the art on the basis of the description of this specification and known techniques without departing from the spirit and scope of the present invention, and these are also included in the range of the request for protection. In addition, the respective components in the embodiments described above may be arbitrarily combined without departing from the scope of the invention.

This invention is based on Japanese Patent Application (Japanese Patent Application No. 2011-055308) filed on Mar. 14, 2011, the content of which is incorporated herein by reference.

### INDUSTRIAL APPLICABILITY

The invention has an effect capable of easily capturing a 3D image with little blurring when performing stereoscopic image capturing, and is useful as an image capture device with a stereoscopic image capturing function or the like in, for example, a digital still camera, a camera function-equipped portable terminal, or the like.

### REFERENCE SIGNS LIST

10: image capture device
11: lens unit
12: image capture element unit
13: image processing unit
14: shutter button
15: camera and lens control unit
16: storage unit
17: display
18: motion vector calculation unit
19: image capture possibility determination unit
21, 31: threshold value calculation unit
50: display screen
51: preview image
52, 62: guidance image
53, 63: current position mark
54: image capturing position mark
64: image capturing position zone display

1. An image capture device configured to perform stereoscopic image capturing to capture two images having a predetermined parallax, the image capture device comprising:
a motion detection unit configured to detect a motion of the image capture device after image capturing of a first image in the stereoscopic image capturing;
an image capturing condition acquisition unit configured to acquire an image capturing condition of an input image during or after image capturing of the first image;
an image capture possibility determination unit configured to detect a stationary state of the image capture device at a position where the predetermined parallax is obtained in accordance with an amount of motion of the image capture device and the image capturing condition, and configured to determine whether or not image capturing of a second image is possible in the stereoscopic image capturing; and
an image capturing control unit configured to control image capturing of the first image and the second image.

2. The image capture device according to claim 1,
wherein, when the amount of motion of the image capture device is equal to or smaller than a threshold value for stationary state detection set in accordance with the image capturing condition, the image capture possibility determination unit determines that the image capture device is in the stationary state.

3. The image capture device according to claim 2,
wherein the image capturing condition is brightness information of the input image.

4. The image capture device according to claim 3, further comprising:
a threshold value calculation unit configured to calculate the threshold value for stationary state detection in accordance with the brightness information,
wherein, when the brightness information is brighter than a predetermined value, the threshold value calculation unit increases the threshold value for stationary state detection compared to when the brightness information is darker than the predetermined value.

5. The image capture device according to claim 2,
wherein the image capturing condition is a distance from a subject during image capturing.

6. The image capture device according to claim 5, further comprising:
a threshold value calculation unit configured to calculate the threshold value for stationary state detection in accordance with the distance from the subject,
wherein, when the distance is greater than a predetermined value, the threshold value calculation unit increases the threshold value for stationary state detection compared to when the distance is smaller than the predetermined value.

7. The image capture device according to claim 1,
wherein, when an amount of movement from an image capturing position of the first image becomes a predetermined amount, on the basis of the amount of motion of the image capture device, the image capture possibility determination unit determines that the image capture device is at the possible image capturing position of the second image where the predetermined parallax is obtained.

8. The image capture device according to claim 7,
wherein, when the amount of movement from the image capturing position of the first image falls within a predetermined allowable range, the image capture possibility determination unit determines that the image capture device is at the possible image capturing position of the second image where the predetermined parallax is obtained.

9. The image capture device according to claim 8, further comprising:
a threshold value calculation unit configured to calculate a threshold value for second image capturing location determination to determine the allowable range of the amount of movement,
wherein the threshold value calculation unit changes the threshold value for second image capturing location determination in accordance with the amount of optimum parallax appropriate for stereoscopic view set as the predetermined parallax.

10. The image capture device according to claim 9,
wherein, when the optimum parallax is greater than a predetermined amount, the threshold value calculation unit increases the threshold value for second image capturing location determination compared to when the optimum parallax is smaller than the predetermined amount.

11. The image capture device according to claim 8, further comprising:
a threshold value calculation unit configured to calculate a threshold value for second image capturing location determination to determine the allowable range of the amount of movement,
wherein the threshold value calculation unit changes the threshold value for second image capturing location determination in accordance with a distance to the subject during image capturing as the image capturing condition.

12. The image capture device according to claim 11,
wherein, when the distance to the subject is greater than a predetermined amount, the threshold value calculation unit increases the threshold value for second image capturing location determination compared to when the distance to the subject is smaller than the predetermined amount.

13. The image capture device according to claim 1, further comprising:
an image capturing location presentation unit configured to present an image capturing location where image capturing of the second image is possible.

14. The image capture device according to claim 13,
wherein the image capturing location presentation unit gives notification of the image capturing location of the second image by at least one of an image, sound, voice, vibration, and light.

15. An image capture method in an image capture device configured to perform stereoscopic image capturing to capture two images having a predetermined parallax, the image capture method comprising:
a step of detecting a motion of the image capture device after image capturing of a first image in the stereoscopic image capturing;
a step of acquiring an image capturing condition of an input image during or after image capturing of the first image;
a step of detecting a stationary state of the image capture device at a position where the predetermined parallax is obtained in accordance with an amount of motion of the image capture device and the image capturing condition, and determining whether or not image capturing of a second image is possible in the stereoscopic image capturing; and
a step of controlling image capturing of the first image and the second image.

16. A program which, in an image capture device performing stereoscopic image capturing to capture two images having a predetermined parallax, causes a computer to execute:
a step of detecting a motion of the image capture device after image capturing of a first image in the stereoscopic image capturing;
a step of acquiring an image capturing condition of an input image during or after image capturing of the first image;
a step of detecting a stationary state of the image capture device at a position where the predetermined parallax is obtained in accordance with an amount of motion of the image capture device and the image capturing condition, and determining whether or not image capturing of a second image is possible in the stereoscopic image capturing; and
a step of controlling image capturing of the first image and the second image.
